(19) United States
(12) Patent Application Publication
(10) Pub. No.: US 2012/0312808 A1
(43) Pub. Date: Dec. 13, 2012

(54) HIGH-FREQUENCY COOKING DEVICE

(75) Inventors: Masaharu Tsujimoto, Shiga (JP); Shinichi Sakai, Shiga (JP); Yuji Hayakawa, Shiga (JP); Kuniaki Abe, Shiga (JP)

(73) Assignee: PANASONIC CORPORATION, Kadoma-shi, Osaka (JP)

(21) Appl. No.: 13/580,647

(22) PCT Filed: Feb. 25, 2011
(86) PCT No.: PCT/JP2011/001124

§ 371 Date: Aug. 22, 2012

(30) Foreign Application Priority Data
Feb. 25, 2010 (JP) 2010-039715

(51) Int. Cl. H05B 6/64

(52) U.S. Cl. 219/756

(57) ABSTRACT

A high-frequency cooking device includes: a heating chamber; a high-frequency generating device; a heating chamber opening portion; a door configured to cover the heating chamber opening portion so as to open and close; a choke portion provided on a peripheral edge portion of the door; and a choke cover which is formed by a resin and which is provided on the door in a position between the choke portion and a peripheral wall portion of the heating chamber opening portion. A ripple is formed on a tip of the choke cover which opposes the choke portion. The ripple seals a portion between the choke portion and the choke cover.

### TECHNICAL FIELD

The present invention relates to a high-frequency cooking device such as a microwave oven.

### BACKGROUND ART

Conventionally, in a high-frequency cooking device of this type, as shown in FIG. 3, a door 7 is attached to a front surface of a microwave oven body 1. An outer peripheral portion of the door 7 is covered with a door surface resin cover 5, and a transparent glass 9 is attached to a center portion of the door 7 so as to allow an inside of a heating chamber 10 to be visible through the transparent glass 9. A partially-punched metal plate 2 including a choke portion 13 is attached to an inner side of the door surface resin cover 5. The choke portion 11 is formed by bending a whole periphery of the metal plate 2. A choke cover 6 is attached to and covers the choke portion 11.

A molded rubber packing 4 is attached around a portion between the metal plate 2 and the choke cover 6. The molded rubber packing 4 allows the door 7 and a heating chamber front surface 3 to come in close contact with each other. Consequently, smoke, steam or the like generated by cooking using a heating chamber 10 is prevented from leaking out of the device or entering an internal space of the door 7 (for example, see Patent Document 1).

As shown in FIG. 4, the following structure is proposed. More specifically, a packing 24 is attached to an inlet port 22 of a choke groove 20. In the packing 24, a receiving groove 26 for receiving a peripheral edge portion 23 of a choke cover 21 is integrally formed in an appropriate position of a hollow cylindrical portion 25. In the structure, a plurality of sealing ribs 28 and 29 is integrally formed with a surface of the packing 24 opposing a back plate 27 so as to protrude therefrom, whereby a foreign substance or steam is prevented from entering an inside of a door from the choke groove 20 (for example, see Patent Document 2).

If the foreign substance or steam enters the inside of the choke groove 20, the steam mists over a glass surface of a front surface of the door, or the foreign substance is observed by a user through the glass. For this reason, an unsanitary impression may be given to the user.

### RELATED ART DOCUMENTS

### Patent Documents

Patent Document 1 : JP-A-8-137563

Patent Document 2 : JP-A-2000-30856

### SUMMARY OF THE INVENTION

### Problem to be Solved by the Invention

However, the conventional structure, require separate members such as the rubber packing 4 or the packing 24, so as to seal a portion between the choke portion 11 and the choke cover 6 in the Patent Document 1 and a portion between the choke cover 21 and the back plate 27 in the Patent Document 2, respectively. For this reason, the conventional structure has problems that the structure is complicated, thereby increasing the number of components increases, or a work for attaching the sealing member to the door is required, thereby deteriorating workability.

The present invention is made to solve the conventional problems, and an object thereof is to provide a high-frequency cooking device capable of ensuring a sealing property between a choke portion and a choke cover without deteriorating an assembling workability of the device.

### Means for Solving the Problem

In order to solve the conventional problems, a high-frequency cooking device of the present invention includes: a heating chamber which is provided in a device body so as to accommodate an object to be heated; a high-frequency generating device configured to supply a high-frequency radio wave to the heating chamber; a heating chamber opening portion which is formed on a front surface of the heating chamber and which allows the object to be heated to be put in and removed from; a door configured to cover the heating chamber opening portion so as to open and close; a choke portion provided on a peripheral edge portion of the door; and a choke cover which is formed by a resin and which is provided on the door in a position between the choke portion and a peripheral wall portion of the heating chamber opening portion, a ripple is formed on a tip of the choke cover which opposes the choke portion, and the ripple seals a portion between the choke portion and the choke cover.

With this configuration, a sealing property between a choke portion and a choke cover is ensured without deteriorating an assembling workability of the device.

### Advantages of the Invention

The high-frequency cooking device of the present invention can prevent a foreign substance or steam from entering from a choke portion to an inside of a door without deteriorating an assembling workability of a device.

### BRIEF DESCRIPTION OF THE DRAWINGS

FIG. 1(a) is a sectional view showing a main part of a door of a high-frequency cooking device according to a first embodiment of the invention, and

FIG. 1(b) is an enlarged sectional view showing an A portion in FIG. 1(a).

FIG. 2(a) is a perspective view showing the door of the high-frequency cooking device according to the first embodiment of the invention, and

FIG. 2(b) is an exploded perspective view showing the door.

FIG. 3 is a sectional view showing a main part of a door of a conventional high-frequency cooking device.

FIG. 4 is a sectional view showing a main part of a door of another conventional high-frequency cooking device.

### MODE FOR CARRYING OUT THE INVENTION

A first invention provides a high-frequency cooking device including: a heating chamber which is provided in a device body so as to accommodate an object to be heated; a high-frequency generating device configured to supply a high-frequency radio wave to the heating chamber; a heating chamber opening portion which is formed on a front surface of the heating chamber and which allows the object to be heated to be put in and removed from; a door configured to cover the heating chamber opening portion so as to open and close; a choke portion provided on a peripheral edge portion of the door; and a choke cover which is formed by a resin and which is provided on the door in a position between the choke portion and a peripheral wall portion of the heating chamber opening portion, wherein a ripple is formed on a tip of the choke cover which opposes the choke portion, and wherein the ripple seals a portion between the choke portion and the choke cover. With this configuration, a foreign substance or steam can be prevented from entering from a choke portion to an inside of a door while the number of components is reduced, and the assembling workability is improved.

In a second invention, a tip portion of the ripple of the first invention is bent toward an inner side of the door so as to urge the ripple. With this configuration, the ripple and the choke portion surface-contact each other, whereby the sealing property can be improved.

In a third invention, a tip portion of the ripple of the first invention is bent toward an outer side of the door, i.e., toward the heating chamber opening portion side, so as to urge the ripple. With this configuration, the ripple and the choke portion surface-contact each other, whereby the sealing property can be improved. Further, the choke cover is pressed toward the door side, whereby a lift of the choke cover can be prevented.

An embodiment according to the invention will be described below with reference to the drawings. The invention is not limited to the embodiment.

### FIRST EMBODIMENT

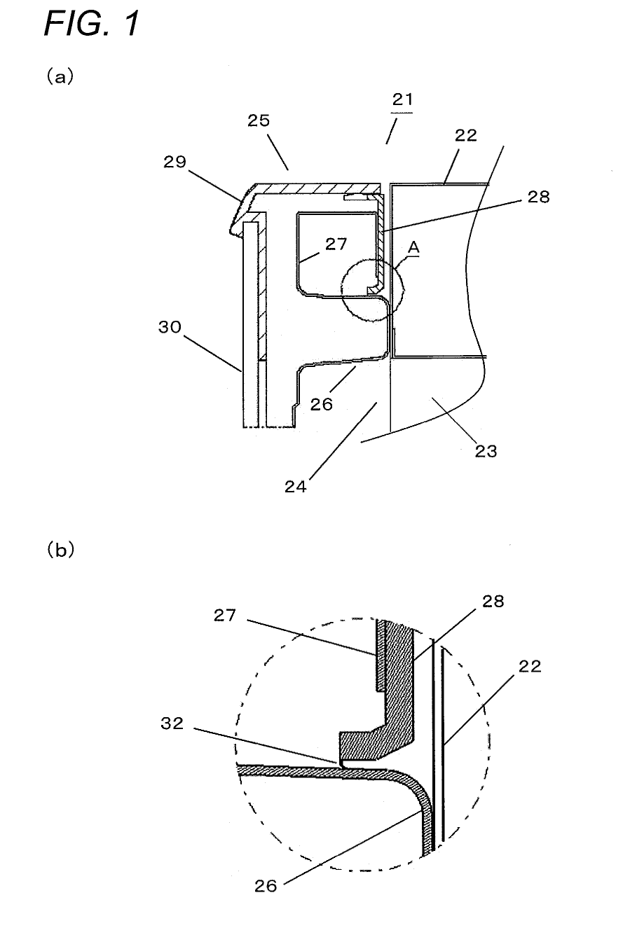

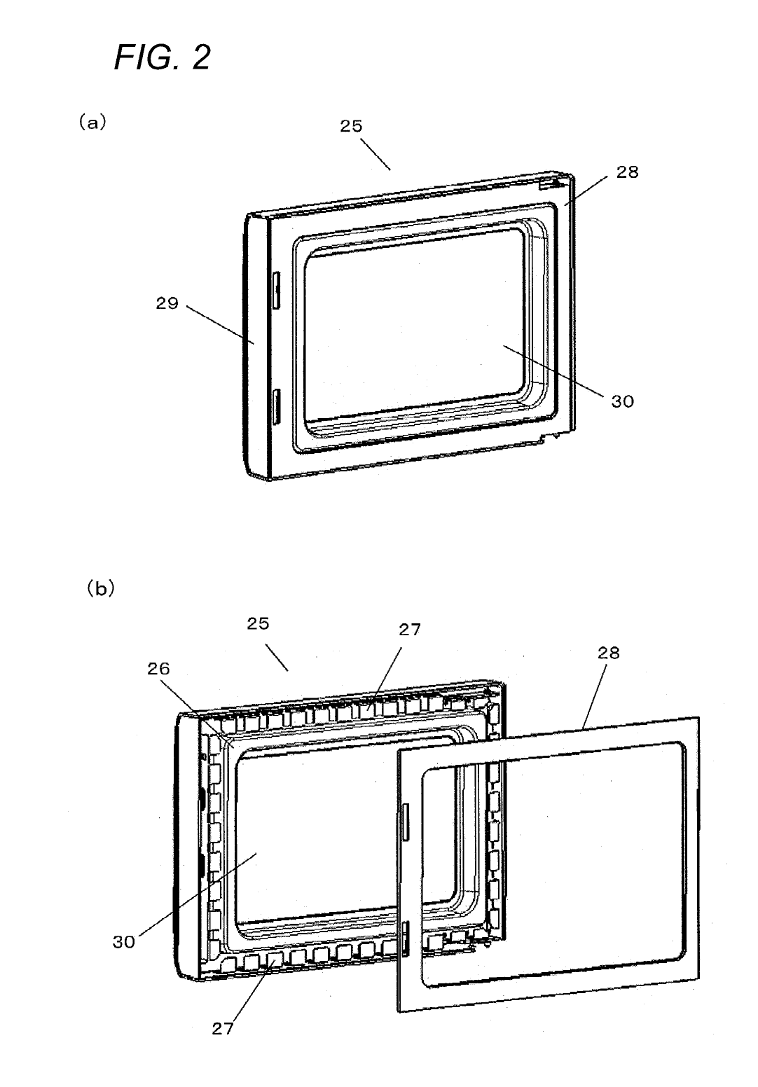

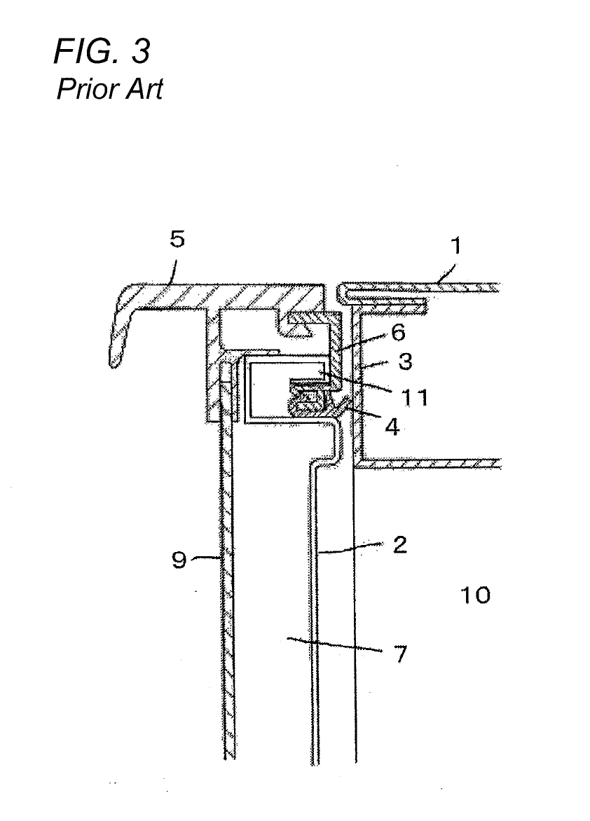

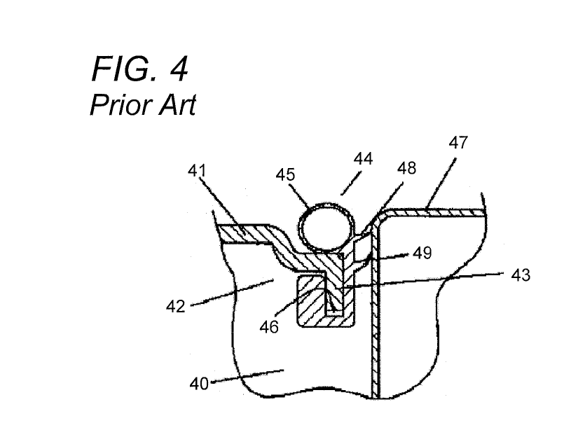

FIG. 1(a) is a sectional view showing a main part of a door of a high-frequency cooking device according to a first embodiment of the invention, FIG. 1(b) is an enlarged sectional view showing an A portion in FIG. 1(a), FIG. 2(a) is a perspective view showing the door of the high-frequency cooking device according to the first embodiment of the invention, and FIG. 2(b) is an exploded perspective view showing the door.

In the drawings, a heating chamber 23 configured to mount a food thereon in heating is provided in a device body 22 of a microwave oven 21 (a high-frequency cooking device). An opening portion 24 is formed on a front surface of the heating chamber 23. A door 25 has a lower side supported at the opening portion 24, such that the door 25 can rotate in a front-rear direction.

The door 25 includes a partially-punched metal plate 26 which faces the opening portion 24 so as to configure a framework of the door 25. A choke portion 27 and a choke cover 28 having a substantially rectangular shape are attached over a whole periphery at a back side of a peripheral edge portion of the metal plate 26, that is, the device body 22 side. The choke portion 27 is formed by processing the metal plate 26 so as to pull up nails which are formed at predetermined intervals and which have a substantially cylindrical shape in cross section. An open end of the choke portion 27 and the metal plate 26 oppose each other through a gap. The gap is defined as an opening (which faces a peripheral edge of the opening portion 24 of the heating chamber 23) of a groove which is formed by the choke portion 27 and which has a rectangular shape as a whole. The choke cover 28 is formed by a polypropylene resin and covers over the groove of the choke portion 27 to hide the groove.

A door surface resin cover 29 is provided so as to uniformly cover a periphery of a front surface of the metal plate 26. A transparent glass 30 is attached to a central part of the metal plate 26 on the heating chamber 23 side. The heating chamber 23 can be viewed through the transparent glass 30 and a punched hole of the metal plate 26. A handle 31 is provided in a width direction of an upper side of the door surface resin cover 29.

The choke cover 28 has a substantially rectangular shape in plan view, and an elastic ripple 32 is integrally formed over a whole periphery of an end on a central side of the choke cover 28. The ripple 32 is configured to seal a clearance between the metal plate 26 (particularly, the choke portion 27) and the choke cover 28.

Hereinafter, operation and function of the high-frequency cooking device having the above-described structure will be explained.

When a food is cooked by the microwave oven 21, the food accommodated in the heating chamber 23 is heated by a high-frequency or a heat of a heater. At this time, smoke, steam or the like is generated from the food and moves to leak out of the microwave oven 21 from the clearance between the metal plate 26 and the choke cover 28. However, a tip of the ripple 32 formed on one of the ends of the choke cover 28 comes in close contact with the metal plate 26. Therefore, the leakage can be prevented.

By urging the ripple 32 or by setting a dimension or an arrangement of the ripple 32 such that the tip portion of the ripple 32 is bent toward the inner side of the door 25, the ripple 32 and the choke portion 27 come in face contact with each other, whereby a sealing property can be enhanced.

By urging the ripple 32 or by setting a dimension or an arrangement of the ripple 32 such that the tip portion of the ripple 32 is bent toward the outer side of the door 25, i.e., toward the heating chamber opening portion 24 side, the ripple 32 and the choke portion 27 come in face contact with each other, whereby the sealing property can be enhanced. Further, with the structure, the choke cover 28 is pressed toward the door 25 side. Thus, it is possible to prevent a lift of the choke cover 28 and to enhance an attaching reliability of the choke cover 28 without spoiling a beauty.

The invention is intended for various changes and applications executed by the skilled in the art based on the description of the specification and the well-known techniques without departing from the scope thereof and is included in the scope of protection. Moreover, the respective components in the embodiments may be combined without departing from the scope of the invention.

The application is based on Japanese Patent Application No. 2010-039715 filed on Feb. 25, 2010, and contents thereof are incorporated herein by reference.

### INDUSTRIAL APPLICABILITY

As described above, in the high-frequency cooking device according to the invention, the choke cover and the choke portion can seal the portion therebetween. Therefore, the invention can also be applied to an industrial high-frequency heating device, in addition to a cooking device.

### DESCRIPTION OF REFERENCE SIGNS

21 Microwave Oven (High-Frequency Cooking Device)
23 Heating Chamber
25 Door
26 Metal Plate
27 Choke Portion
28 Choke Cover
32 Ripple

1. A high-frequency cooking device comprising:
a heating chamber which is provided in a device body so as to accommodate an object to be heated;
a high-frequency generating device configured to supply a high-frequency radio wave to the heating chamber;
a heating chamber opening portion which is formed on a front surface of the heating chamber and which allows the object to be heated to be put in and removed from;
a door configured to cover the heating chamber opening portion so as to open and close;
a metal plate which configures a framework of the door and which is partially punched;
a choke portion which has a groove and which is provided on a peripheral edge portion of the metal plate and over a whole periphery on the device body side of the metal plate; and
a choke cover which is formed by a resin, which covers over the groove of the choke portion to hide the groove, and which is provided on the door in a position between the choke portion and a peripheral wall portion of the heating chamber opening portion,
wherein a ripple is integrally formed on a tip of the choke cover which opposes the choke portion, and
wherein the ripple comes in close contact with the metal plate and seals a portion between the choke portion and the choke cover.

2. The high-frequency cooking device according to claim 1, wherein a tip portion of the ripple is bent toward an inner side of the door so as to urge the ripple.

3. The high-frequency cooking device according to claim 1, wherein a tip portion of the ripple is bent toward an outer side of the door so as to urge the ripple.
